(19) United States
(12) Patent Application Publication
(10) Pub. No.: US 2004/0203746 A1
(43) Pub. Date: Oct. 14, 2004

(54) Location-specific collaboration for mobile devices

(76) Inventors: Robert C. Knauerhase, Portland, OR (US); Nikhil M. Deshpande, Beaverton, OR (US)

Correspondence Address: Blakely, Sokoloff, Taylor & Zafman, Seventh Floor, 12400 Wilshire Boulevard, Los Angeles, CA, 90025-1030, US

(21) Appl. No.: 10/112,387

(22) Filed: Mar. 28, 2002

(51) Int. Cl. H04Q 7/20

(52) U.S. Cl. 455/432.1; 455/435.1

(57) ABSTRACT

According to an embodiment of the invention, the location of a mobile client device is determined, the location being in a region. One or more potential communication partners for the mobile client device are identified for the region, the identification being based at least in part on the location of the mobile client device in the region. Contact information is provided to the mobile client device regarding the potential communication partners for the region.

Contained herein is material that is subject to copyright protection. The copyright owner has no objection to the facsimile reproduction by anyone of the patent document or the patent disclosure, as it appears in the United States Patent and Trademark Office patent file or records, but otherwise reserves all rights to the copyright whatsoever. The following notice applies to the software and data as described below and in the drawings hereto: Copyright© 2002, Intel Corporation, All Rights Reserved.

### FIELD

An embodiment of invention relates to communications in general, and more specifically to location-specific collaboration for mobile devices.

### BACKGROUND

Mobile devices containing communications capability, including personal digital assistants (PDAs), portable computers, and advanced cellular telephones, allow communication with other persons or devices as long as the mobile device is in range of a communications network. For communication purposes, a mobile device may have a list of potential communication partners, or a “buddy list”, available. However, it generally isn't possible to determine which of the communication partners are in the same location or region as the mobile device.

A conventional communication network, such as an instant messaging (IM) system, may include presence information, which is information concerning whether particular contacts are currently connected to the network. However, this concept of presence does not include information regarding physical location of a potential contact. A conventional communication network for a mobile device thus will not provide information regarding whether a potential contact is located in the same area as the mobile device.

In a conventional network, it may be possible for a mobile device to receive information regarding possible communication partners that are in range of a particular network, and therefore are connected to the network. However, the information received is not based upon the location of the communication partner, but is instead based upon the ability of the communication partner to receive a signal and log on to the network.

### BRIEF DESCRIPTION OF THE DRAWINGS

The invention may be best understood by referring to the following description and accompanying drawings that are used to illustrate embodiments of the invention. In the drawings:

FIG. 1 illustrates of a mobile client device located in a region under an embodiment of the invention;

FIG. 2 illustrates an embodiment of a mobile client device that moves from a first region into a second region;

FIG. 3 illustrates an embodiment of a system in which a first region overlaps with a second region;

FIG. 4 illustrates an embodiment of a system in which a first region is wholly within a second region;

FIG. 5 is a flowchart of an embodiment of location specific collaboration for a client device;

FIG. 6 is flowchart of an embodiment of location specific collaboration for a server; and

FIG. 7 is a block diagram illustrating an exemplary mobile client device that may be utilized in connection with an embodiment of the invention.

### DETAILED DESCRIPTION

A method and apparatus are described for location-specific collaboration with mobile devices. According to an embodiment of the invention, the location of a mobile client device is monitored. Information regarding potential communication partners for a particular region is provided when the device is located within the region and the information is deleted when the device leaves the region.

In the following description, for the purposes of explanation, numerous specific details are set forth. However, it is understood that embodiments of the invention may be practiced without these specific details. In other instances, well-known circuits, structures, techniques, and devices have not been shown in detail in order not to obscure the understanding of this description.

Embodiments of the invention include various processes, which will be described below. The processes may be performed by hardware components or may be embodied in machine-executable instructions, which may be used to cause a general-purpose or special-purpose processor or logic circuits programmed with the instructions to perform the processes. Alternatively, the processes may be performed by a combination of hardware and software.

### Terminology

Before describing an exemplary environment in which various embodiments of the present invention may be implemented, some terms that will be used throughout this application will briefly be defined:

As used herein, “mobile client device” means any device that is mobile and that is capable of communication functions. A mobile client device includes, but is not limited to, a personal digital assistant (PDA) with communication functions; a mobile computer with wireless network access, including a laptop or notebook computer; a computer installed in a motor vehicle that may be connected to a network; a cellular telephone; and other such devices.

As used herein, “buddy list” means a list of contacts with whom to communicate.

As used herein, “potential communication partners” means people, services, or things that may be sources and/or recipients of communications.

As used herein, “advanced presence” means presence information that includes data relating to physical location.

Under an embodiment of the invention, a mobile client device operates in a network. An application in the network infrastructure monitors the mobile client device's location. When the mobile client device enters a particular area or region, the network provides information regarding potential communication partners to the mobile client device, the potential communication partners being chosen at least in part based on the location of the device in the area or region. If the mobile client device leaves the area or region, the information regarding potential communication partners corresponding to the area or region is deleted from the device.

Embodiments of the invention described herein involve provision of information regarding potential communication partners. The identity of communication partners will vary depending on the individual embodiment. For example, communication partners may be human beings for certain embodiments and may be computers, software, services, or other electronic devices in certain embodiments.

The embodiments described herein refer to determining and monitoring the location of a mobile client device. The determination of the location of a mobile client device may be accomplished by any method. The location of a mobile device may be determined by obtaining updates from the device, such as by global positioning satellite (GPS) or any other system; by receiving updates from the infrastructure, such as by a cellular roaming database; by subscribing to the client's presence if the presence includes physical location of the mobile client device; or by any other known method. In one embodiment of the invention, the mobile device or the network may allow the user to input a location. In one particular embodiment, a particular building or facility may have an established code that may be input by the user. Similarly, the change of location of a mobile device may be input by the user when the user moves to a different location.

According to an embodiment of the invention, potential communication partners for a mobile client device are identified at least in part based on the location of the mobile client device in a particular area or region. In one example, the communication partners may themselves be located in the same area or region. In another example, the communication partners may provide services or information related to the area or region and thus are relevant to that area or region.

According to an embodiment of the invention, the information regarding potential communication partners is provided to a mobile client device by adding the partners to the buddy list of the client. In such an embodiment, the buddy list associated with a mobile device is a dynamic list that is supplemented in a context-related fashion. Under this embodiment, the network provides for automatic addition and deletion of contacts from the buddy list dependent at least in part on the physical location of the mobile device. When it is determined that a mobile device is located in a particular area, contact information may be added to the buddy list associated with the mobile device. In another embodiment, a separate supplemental buddy list may be established, the supplemental buddy list including location-specific communication partners. In an embodiment in which a supplemental buddy list is established, overlap with an existing buddy list may occur depending on the particular system implemented.

Under an embodiment of the invention, when a mobile device moves out of a first area, the system may provide for the automatic deletion of contact information that was added to the buddy list related to the presence of the mobile device in the first area. The process of contact information deletion depends on the particular embodiment. In one embodiment, the mobile device may delete the contact information automatically. In another embodiment, the network server may provide an instruction to delete the information. When the mobile device is determined to have moved into a second area, the system may then provide for the addition of contact information that is associated with the second area.

In certain embodiments of the invention, the user of the mobile client device is familiar with the communication partners and may have added the communication partners as potential members of a buddy list. The addition of the communication partners to the buddy list may inform the user of the mobile client device that persons or services the user knows are in the same area or region as the device user. In certain other embodiments, the user of a mobile device may not be familiar with the added potential communication partners corresponding to a particular area or region. According to one embodiment, potential communication partners corresponding to a particular location are also notified regarding the physical presence of the mobile client device in the area or region.

In a particular embodiment of the invention, the communication system includes an instant messaging system. In the conventional instant messaging system, presence of a person indicates whether a person is or is not connected to the network at any time. However, network presence does not indicate physical presence of a person in any location. In a new concept of advanced presence, a buddy list may also incorporate physical location information. Under an embodiment, an instant message system includes a buddy list with advanced presence information, the advanced presence including information regarding which potential communication partners on the buddy list for a mobile device are in the proximity of the mobile device or are within a certain range of the mobile device.

While the embodiments described herein generally refer to a network infrastructure, other possible communications arrangements may be used in certain embodiments. For example, a peer to peer communication model may be implemented in which mobile devices communicate directly with each other.

In some embodiments of the invention, a mobile client device in moving from one area to another may move from one type of communication service to another. In some embodiments, one communication service may be a wireless ethernet protocol, particularly a service provided under Institute of Electrical and Electronics Engineers (IEEE) standard 802.11b for wireless local area networks (WLAN) (IEEE, September 1999). In some embodiments, one communication service may be a cellular telephone network or similar service.

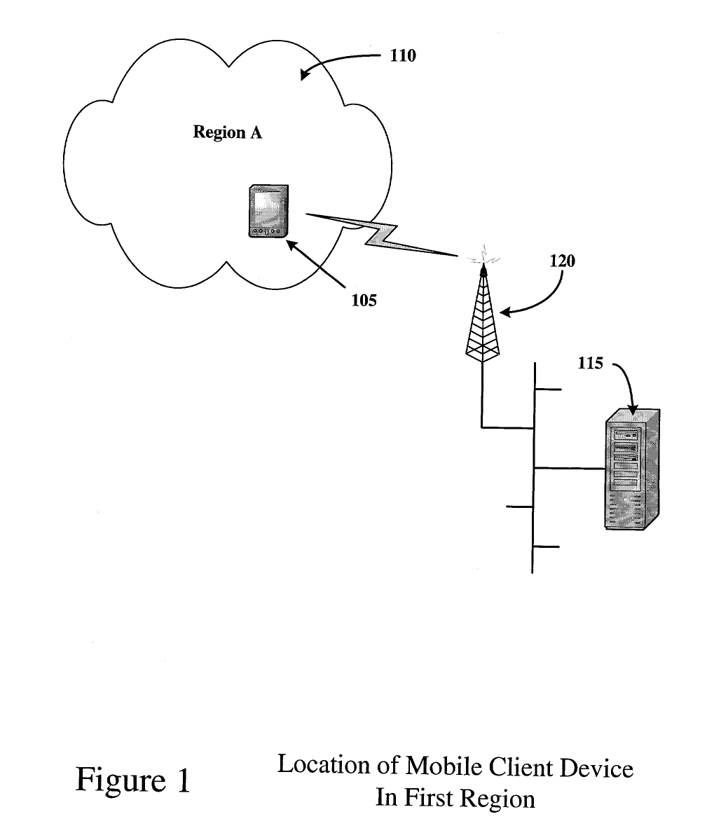

FIG. 1 illustrates an embodiment of a mobile client device operating within a given region. Note that for simplicity FIG. 1 and the other figures presented herein illustrate a handheld computer or PDA as the mobile client device. Embodiments are not limited to such a device and may include any mobile client device. The location of mobile client device 105 is determined by any known method. In this example, it is determined that mobile client device 105 is located within a first region designated as region A 110. In this embodiment, mobile client device 105 may update the presence information for the device to indicate presence within region A. Mobile client device 105 transmits the location to the server 115 for the network. For this illustration, an antenna 120 is shown as providing signal transmission for region A 120, but the actual wireless transmission system will depend on the system embodiment.

In FIG. 1, the network includes an embodiment of an application in a network infrastructure to support location-specific collaboration with the mobile client device 105. In this embodiment the infrastructure application is stored on the server 115, but in other embodiments the application may exist in another portion of the network. The server 115 evaluates the location of the mobile client device 105 and determines whether any contact information is available for mobile client device 105 corresponding to region A 110. The contact information may include additional buddies on the buddy list for the mobile client device 105. The contact information corresponding to region A 110 is then transmitted to the mobile client device 105.

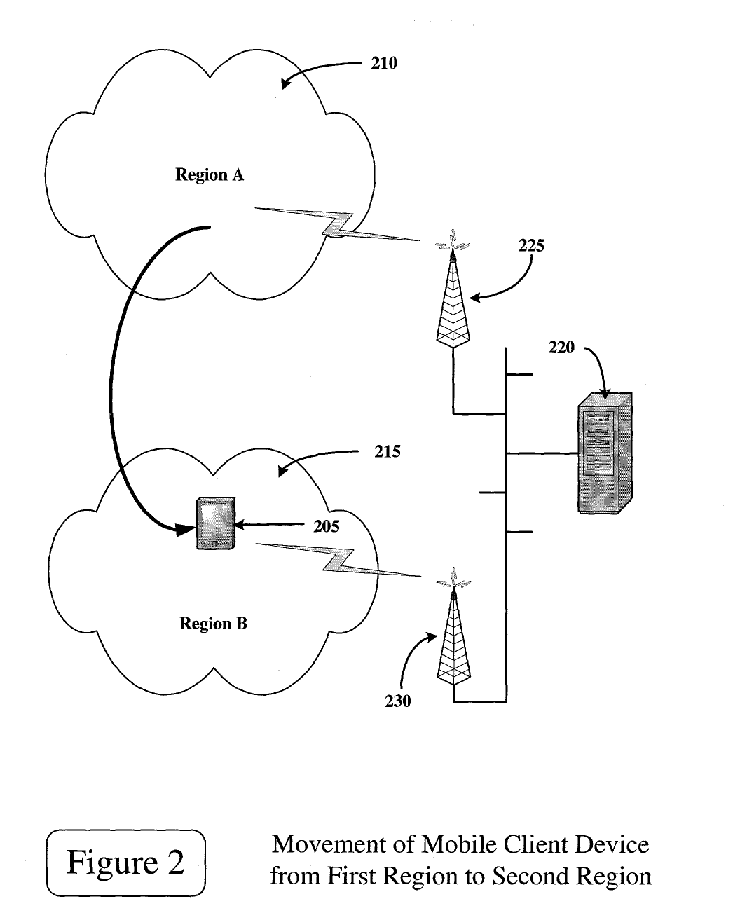

FIG. 2 illustrates an embodiment of the invention in which a device has moved out of a first region into a second region. In this illustration, mobile client device 205 was previously located within a first region, region A 210, shown to be serviced by a first antenna 225 but has since moved into a second region, region B 215, shown to be serviced by a second antenna 230. The location of mobile client device 205 is determined by any known method. In this instance, the location determination finds that mobile client device 205 is located in region B 215 and has moved out of region A 210. Under a particular embodiment, the mobile client device 210 then updates the presence information for the device with the new location. The mobile client device 205 notifies the server 220 for the network regarding the new location of the device. After moving into region B 215, mobile client device 205 will delete contact information that corresponded to region A 210. In a certain embodiment, the server 220 will transmit an instruction to the mobile client device 205 to delete the contact information corresponding to the previous location of the device. The server 220 determines whether there is any contact information corresponding to region B 215 for the mobile client device 205. As with region A, the contact information may include additional buddies on the buddy list for the mobile client device 205. Any contact information corresponding to region B 215 is then transmitted to the mobile client device 205.

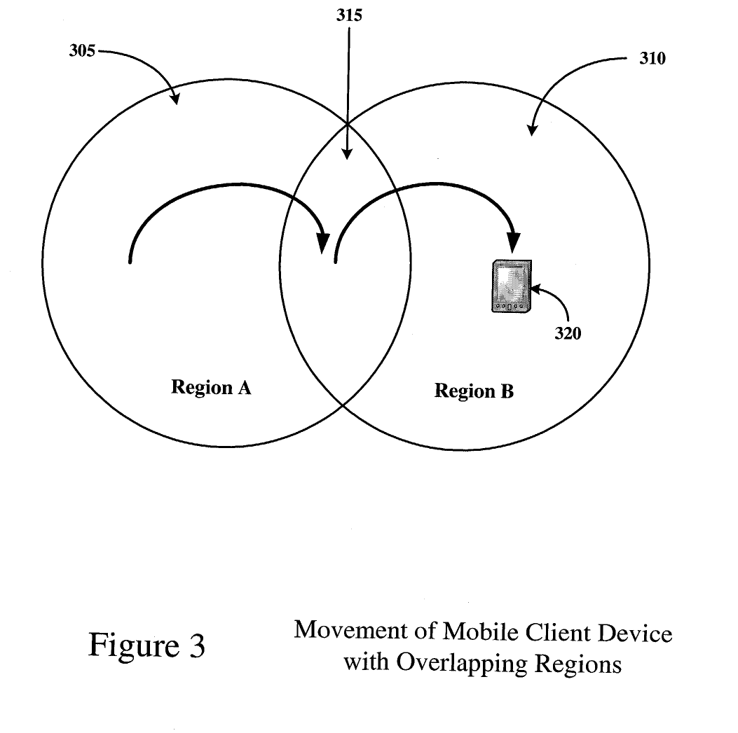

For simplicity, FIG. 2 illustrates a first region and a second region that are separate from each other. However, in other embodiments of the invention the arrangement of regions may vary. For example, in a certain embodiment of the invention, a first region may overlap with a second region. In another embodiment, a first region may be wholly within a second region. In FIG. 3, region A 305 overlaps with region B 310. In this example, there is an overlapping area 315 that is included within both region A 305 and region B 310 and in which contact information for both region A 305 and region B 310 will be relevant. In this example, the operation of a mobile client device 320 may vary from operations in which regions are wholly separate. In moving from the non-overlapping area of region A 305 to the overlapping area 315, the mobile client device 320 has changed location and has entered region B 310, but has not left region A 305. In a particular embodiment, the mobile client device 320 receives contact information corresponding to region B 310 upon a determination that the device is within the overlapping region 315, but will not delete contact information corresponding to region A 305 because the device remains within region A 305 as well. If the mobile client device 320 subsequently moves from the overlapping area 315 into the remaining portion of region B 310, the device deletes the contact information corresponding to region A 305 but does not receive further contact information because the contact information corresponding to region B 310 has previously been received.

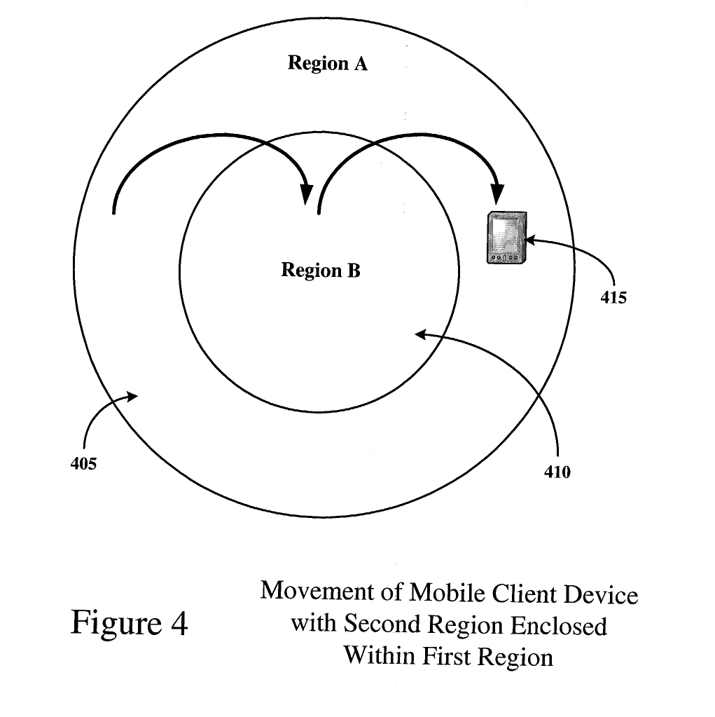

In FIG. 4, region B 410 is wholly within region A 405. In this example, mobile client device 415 may initially be in region A 405 outside of region B 410 and receive contact information regarding region A 405. The mobile client device may subsequently move into region B 410 and thus will be within both region A 405 and region B 410 simultaneously. In a particular embodiment, the mobile client device 415 receives contact information corresponding to region B 410 upon a determination that the device is within the region, but will not delete contact information corresponding to region A 405 because the device remains within region A 405 as well. If the mobile client device 415 subsequently moves out of region B 410 into a portion of region A 405, the device deletes the contact information corresponding to region B 410 but does not receive further contact information because the contact information corresponding to region A 405 has previously been received. The contact information corresponding to region A 405 will be deleted when the mobile client device 415 moves outside of the region.

The specific regions or areas involved in a communication system are dependent on the individual embodiment of the invention. One example of an embodiment of the invention may involve the determination that the mobile device is located in a particular public place, such as a retail store, an arena or theater, a restaurant or nightclub, or other facility. Upon determining the location in a given area, the system may add contact information that is appropriate for the given location. The type and number of contacts added may vary greatly depending upon the context, location, subscription payments, and other factors.

If an arena or theater is a recognized region, one embodiment of the invention may provide contact information regarding friends and family members of the user of the mobile device so that the user can seek out and communicate with these individuals in the facility. If a nightclub or similar locale is a recognized region, one embodiment may provide contact information regarding single individuals with similar interests who are present in the facility. A particular embodiment may provide different types of contact information and different classes of communication partners dependent on what type of region or area is recognized.

Under a particular embodiment of the invention, communication partners may be human or may be autonomous sources of information. For instance, in one embodiment a communication partner may be a specialized computer system that can provide information that is relevant to the particular area or location.

In addition to any other factor, the information provided to a particular mobile client device may be affected by how the information is filtered. In one embodiment, the user of a mobile client device has established filtering parameters that affect what communication partners are identified. For instance, if the mobile client device has a buddy list associated with it, the user may choose which persons on the buddy list the user wishes to be informed about. In another embodiment, the user of a mobile client device may decide in what contexts the user wishes to receive certain varieties of communication partner information.

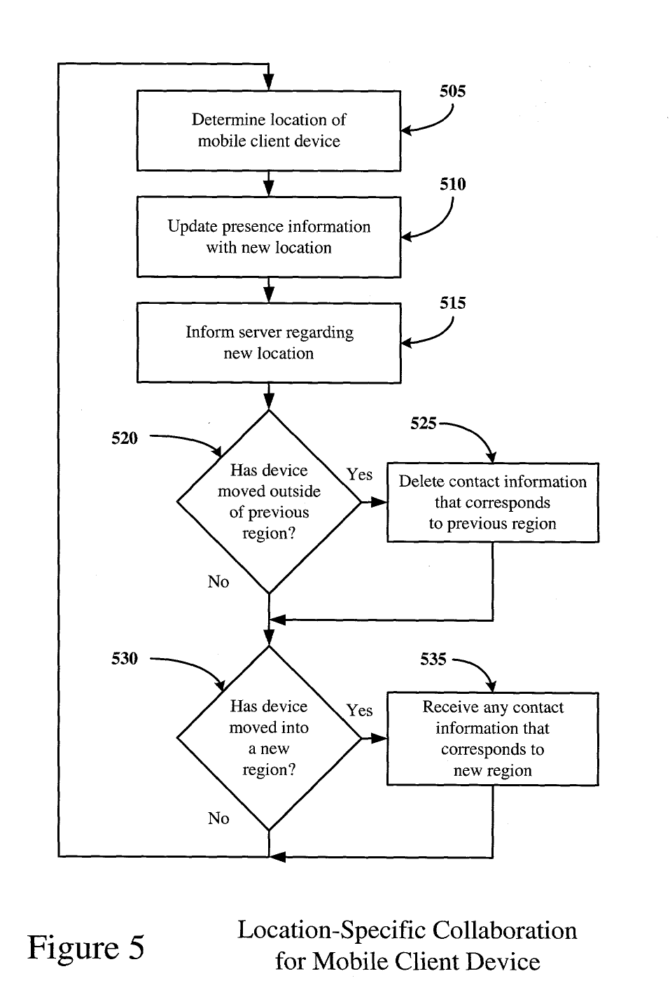

FIG. 5 illustrates an embodiment of the invention involving location specific collaboration for a mobile client device. The location of a mobile client device is determined, process block 505, with such location determination being made by any method. The client device then may update presence information with the new location, process block 510, and inform the server regarding the new location, process block 515. If the mobile client device has moved outside of a previously recognized region, process block 520, then contact information regarding potential communication partners that corresponds to the region previously occupied is deleted. Under a particular embodiment, the deletion of contact information is the deletion of contacts added to the buddy list for the mobile client device that correspond to the region previously occupied. There is a determination whether the mobile client device has moved into a new region that is recognized, process block 530. If so, the mobile client device receives any contact information that corresponds to the newly occupied region, process block 535. Under a particular embodiment, the contact information is provided by a server for the network in which the mobile client device operates. The system then returns to the determination of the location of the mobile client device, process block 505.

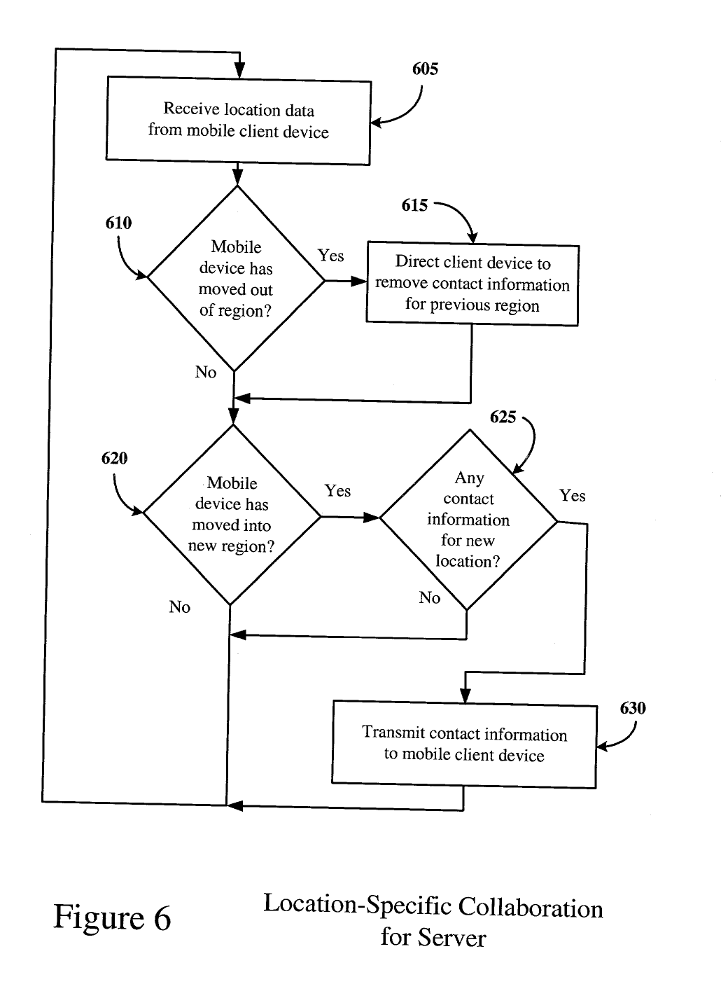

FIG. 6 illustrates an embodiment of the invention involving location specific collaboration for a server. In this embodiment, a server for a network that includes a mobile client device receives location data from the mobile client device, process block 605. Under a particular embodiment, if the mobile client device has moved out of a previously recognized region, process block 610, the server directs the mobile client device to remove contact information corresponding to the region previously occupied, process block 615. In another embodiment, the mobile client device may automatically remove the contact information for the region previously occupied. If the mobile client device has moved into a new region that is recognized, process block 620, there is a determination whether there is any contact information regarding potential communication partners corresponding to the newly occupied region. If so, the contact information is transmitted to the mobile client device, process block 630. The process then returns to the reception of location data from the mobile client device, process block 605.

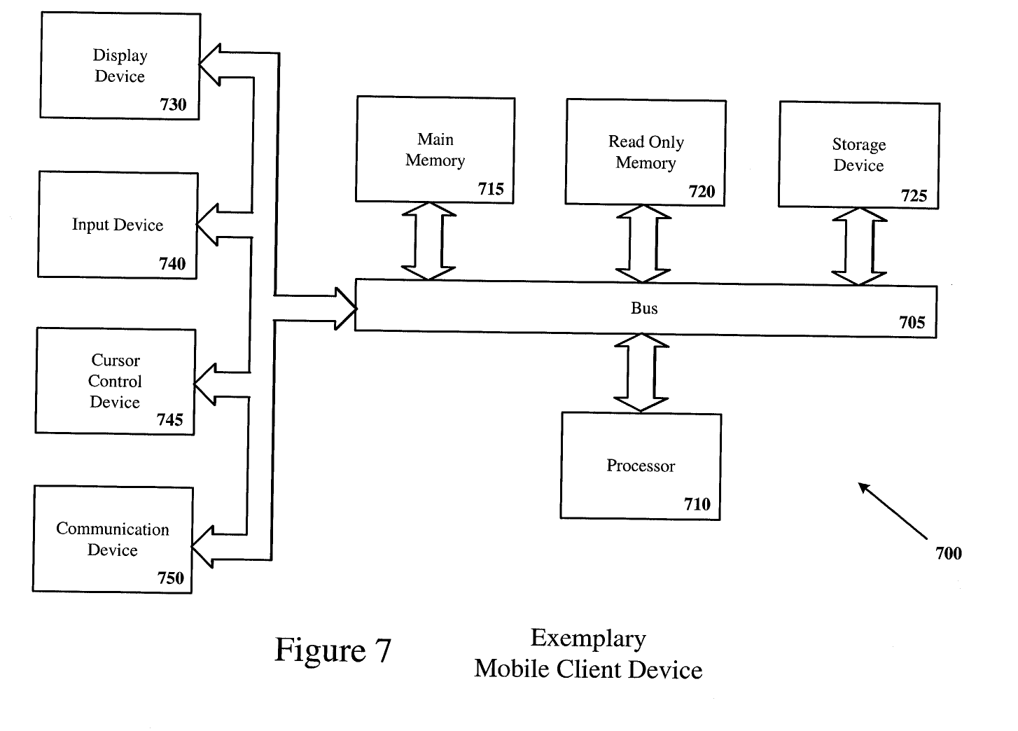

FIG. 7 is a block diagram illustrating an exemplary mobile client device that may be utilized under an embodiment of the invention. Not all mobile client devices are structured as shown in FIG. 7. In addition, certain mobile client devices may utilize elements shown in FIG. 7 as auxiliary devices that are external from the mobile client device. Under an embodiment of the invention, a mobile client device 700 comprises a bus 705 or other communication means for communicating information, and a processing means such as a processor 710 coupled with the bus 705 for processing information. The mobile client device 700 further comprises a random access memory (RAM) or other dynamic storage device as a main memory 715 for storing information and instructions to be executed by the processor 710. Main memory 715 also may be used for storing temporary variables or other intermediate information during execution of instructions by the processor 710. The mobile client device 700 also may comprise a read only memory (ROM) 720 and/or other static storage device for storing static information and instructions for the processor 710.

A data storage device 725 may also be coupled to the bus 705 of the mobile client device 700 for storing information and instructions. The data storage device 725 may include a magnetic disk or optical disc and its corresponding drive, flash memory or other nonvolatile memory, or other memory device. The mobile client device 700 may also be coupled via the bus 705 to a display device 730, such as a liquid crystal display (LCD) or other display technology, for displaying information to an end user. In some environments, the display device may be a touch-screen that is also utilized as at least a part of an input device. In some environments, display device 730 may be or may include an auditory device, such as a speaker for providing auditory information. An input device 740 may be coupled to the bus 705 for communicating information and/or command selections to the processor 710. In various implementations, input device 740 may be a keyboard, a keypad, a touch-screen and stylus, a voice activated system, or other input device, or combinations of such devices. Another type of user input device that may be included is a cursor control device 745, such as a mouse, a trackball, or cursor direction keys for communicating direction information and command selections to processor 710 and for controlling cursor movement on display device 730.

A communication device 750 may also coupled to the bus 705. Depending upon the particular implementation, the communication device 750 may include a transceiver, a wireless modem, a network interface card, or other interface device. The mobile client device 700 may be linked to a network or to other devices using the communication device 750, which may include links to the Internet, a local area network, or another environment.

The invention has been described in terms of several embodiments. However, those skilled in the art will recognize that the invention is not limited to the embodiments described, but rather that modifications and changes may be made thereto without departing from the broader spirit and scope of the invention. The specification and drawings are thus to be regarded as illustrative rather than limiting.

What is claimed is:

1. A mobile client device comprising:
a processor;
a wireless link to a network, the infrastructure of the network receiving information regarding the location of the mobile client device, the mobile client device being initially located in a first region; and
a memory, data stored in such memory including a list of potential communication partners, the list including information concerning potential communications partners for the first region, the information being transferred to the mobile client device by the network, the potential communications partners for the first region being identified by the network based at least in part on the location of the mobile client device in the first region.

2. The mobile client device of claim 1, wherein the information concerning potential communications partners for the first region is deleted if the mobile client device leaves the first region.

3. The mobile client device of claim 2, wherein if the mobile client device enters a second region, the network identifies potential communications partners for the second region and transfers information concerning the potential communications partners for the second region to the mobile client device, the potential communications partners for the first region being identified by the network based at least in part on the location of the mobile client device in the second region.

4. The mobile client device of claim 1, wherein the list of potential communication partners comprises a buddy list for the mobile client device.

5. The mobile client device of claim 4, wherein the potential communication partners for the first region comprise one or more of persons, applications, or services that the network identifies as being relevant to the mobile client device when the mobile client device is located in the first region.

6. A wireless network comprising:
a server, the server receiving information regarding the location of the mobile client device, the mobile client device being initially located in a first region; and
data regarding potential communication partners for the mobile client device, the server providing information to the mobile client device regarding potential communication partners for the first region, the potential communication partners being chosen by the server at least in part based on the location of the mobile client device in the first region.

7. The wireless network of claim 6, wherein if the mobile client device leaves the first region, the server directs the mobile client device to delete the information regarding the potential communication partners for the first region.

8. The wireless network of claim 6, wherein if the mobile client device leaves the first region, the mobile client device automatically deletes the information regarding the potential communication partners for the first region.

9. The wireless network of claim 8, wherein if the mobile client device enters a second region, the server provides information to the mobile client device regarding potential communication partners for the second region, the potential communication partners for the second region being chosen at least in part based on the location of the mobile client device in the second region.

10. A communication system comprising:
means for determining the location of a mobile client device;
means for identifying potential communication partners for the mobile client device, the identification of the potential communication partners being based at least in part on the location of the mobile client device in a region; and
means for providing information regarding the potential communications partners to the mobile client device.

11. The communications system of claim 10, further comprising means for determining that the mobile client device has left the region.

12. The communications system of claim 11, further comprising means for deleting the information regarding the potential communications partners upon the mobile client device leaving the region.

13. A method comprising:
determining the location of a mobile client device, the location being initially in a first region;
identifying one or more potential communication partners for the mobile client device for the first region, the identification being based at least in part on the location of the mobile client device in the first region; and
providing contact information to the mobile client device regarding the potential communication partners for the first region.

14. The method of claim 13, further comprising updating presence information for the mobile client device based on the location of the mobile client device.

15. The method of claim 13, further comprising:
determining that the mobile client device is no longer in the first region.

16. The method of claim 15, further comprising:
upon determining that the mobile client device is no longer in the first region, deleting the contact information regarding potential communication partners for the first region.

17. The method of claim 16, further comprising:
determining that the mobile client device is located in a second region;
identifying one or more potential communication partners based at least in part on the location of the mobile client device in the second region; and
providing contact information to the mobile client device regarding the potential communication partners for the second region.

18. The method of claim 13, further comprising providing information to the potential client partners regarding the location of the mobile client device in the first region.

19. The method of claim 13, wherein providing contact information to the mobile client device regarding the potential communication partners for the first region comprises a temporary expansion of a buddy list associated with the mobile client device.

20. A machine-readable medium having stored thereon data representing sequences of instructions that, when executed by a processor, cause the processor to perform operations comprising:
determining the location of a mobile client device, the location being initially in a first region;
identifying one or more potential communication partners for the mobile client device for the first region, the identification being based at least in part on the location of the mobile client device in the first region; and
providing contact information to the mobile client device regarding the potential communication partners for the first region.

21. The medium of claim 20, further comprising instructions that, when executed by the processor, cause the processor to perform operations comprising:
updating presence information for the mobile client device based on the location of the mobile client device.

22. The medium of claim 20, further comprising instructions that, when executed by the processor, cause the processor to perform operations comprising:
determining that the mobile client device is no longer in the first region.

23. The medium of claim 22, further comprising instructions that, when executed by the processor, cause the processor to perform operations comprising:
upon determining that the mobile client device is no longer in the first region, deleting the contact information regarding potential communication partners for the first region.

24. The medium of claim 23, further comprising instructions that, when executed by the processor, cause the processor to perform operations comprising:
determining that the mobile client device is located in a second region;
identifying one or more potential communication partners based at least in part on the location of the mobile client device in the second region; and
providing contact information to the mobile client device regarding the potential communication partners for the second region.

25. The medium of claim 20, further comprising instructions that, when executed by the processor, cause the processor to perform operations comprising:
providing information to the potential client partners regarding the location of the mobile client device in the first region.

26. The medium of claim 20, wherein providing contact information to the mobile client device regarding the potential communication partners for the first region comprises a temporary expansion of a buddy list associated with the mobile client device.
